(19) United States
(12) Patent Application Publication
(10) Pub. No.: US 2017/0255974 A1
(43) Pub. Date: Sep. 7, 2017

(54) CONTEXT AWARE TRANSACTION MANAGEMENT SYSTEM

(71) Applicant: PAYPAL, INC., San Jose, CA (US)

(72) Inventor: Shyamsundar Kulkarni, San Jose, CA (US)

(21) Appl. No.: 15/058,928

(22) Filed: Mar. 2, 2016

(51) Int. Cl. G06Q 30/04; G06Q 20/14; G06Q 10/08

(52) U.S. Cl. CPC G06Q 30/04; G06Q 10/08345; G06Q 20/14

(57) ABSTRACT

Systems and methods for providing invoice management and payment recommendations based on communication information include receiving, from a merchant device associated with the merchant through a network, communication information associated with a transaction provided by a communication application; determining transaction information associated with the transaction using the communication information; retrieving, from at least one database, a first invoice configuration associated with the transaction; generating a first invoice associated with a first customer associated with the transaction using the first invoice configuration; and providing the first invoice over the network for display on a first customer device associated with the first customer.

### BACKGROUND

The present disclosure generally relates to transaction management systems used over electronic networks and more particularly to a transaction management system that generates invoices by using communication information provided by communication applications.

More and more consumers are conducting transactions, such as purchasing items and services, over electronic networks such as, for example, the Internet. Consumers routinely purchase products and services from merchants and individuals alike. The transactions may take place directly between a physical or on-line merchant or retailer and the consumer, and payment is typically made by entering credit card or other financial information. Transactions may also take place with the aid of an on-line or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why on-line and mobile purchases are growing very quickly.

Communication applications, such as email applications, are commonly used by customers and merchants to communicate about a transaction, for example, to place an order, to request a refund for a defective product, to confirm an order, or to cancel the transaction. However, to perform an action for that transaction or to update the status of the transaction according to the communication, the merchant and/or the customer is typically required to manually input the relevant information using an application different from those communication applications. For example, to generate an invoice for an order placed by an email, merchants are typically required to manually input information relating to the transaction to traditional invoice applications. This adds additional steps to the transaction, increases the complexity of the transaction, and can introduce human error.

Embodiments described herein provide for a system to facilitate management of transactions including generation of invoices by using communication information provided by communication applications.

### BRIEF DESCRIPTION OF THE FIGURES

FIG. 1 is a flow chart illustrating an embodiment of a method for providing transaction management;

FIG. 2 is a screen shot illustrating an embodiment of a merchant device displaying an email application screen;

FIG. 3A is a screen shot illustrating an embodiment of a merchant device displaying a messaging application screen;

FIG. 3B is a screen shot illustrating an embodiment of a merchant device displaying a calendar application screen;

FIG. 4 is a screen shot illustrating an embodiment of a merchant device displaying an invoice configuration screen;

FIG. 5 is a screen shot illustrating an embodiment of a merchant device displaying an invoice review screen;

FIG. 6 is a screen shot illustrating an embodiment of a customer device displaying an email application screen;

FIG. 7 is a screen shot illustrating an embodiment of a customer device displaying an email application screen;

FIG. 8 is a screen shot illustrating an embodiment of a merchant device displaying an email application screen;

FIG. 9A is a screen shot illustrating an embodiment of a customer device displaying an email application screen;

FIG. 9B is a screen shot illustrating an embodiment of a customer device displaying an email application screen;

FIG. 10 is a schematic view illustrating an embodiment of a networked system;

FIG. 11 is a perspective view illustrating an embodiment of a merchant device;

FIG. 12 is a schematic view illustrating an embodiment of a computer system; and

FIG. 13 is a schematic view illustrating an embodiment of a system provider device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for providing context aware transaction management using communication information provided by communication applications. As discussed above, communication applications, such as email applications, are commonly used by customers and merchants to communicate about a transaction. However, to perform an action for that transaction or to update the status of the transaction according to the communication, merchants and/or customers may be required to provide relevant transaction information to an application (e.g., an invoice application) different from the communication application, which increases the complexity of the transaction. To address such concerns, in embodiments of the systems and methods described herein, a system provider (e.g., the payment service provider discussed below) may automatically determine transaction information associated with the transaction using the communication information, and perform a requested action for the transaction (e.g., invoice generation) using the determined transaction information. Moreover, the system provider may provide various notifications (e.g., transaction risk notification, payment reminder notification) associated with the transaction to the merchant or the customer through the communication application, and receive actions for the transaction from the merchant or the customer from the communication application. As such, the merchant or customer gains the convenience of managing transactions using the communication application.

It is noted that while examples of certain types of communication applications are discussed below, these examples are not intended to be limiting. The transaction management may be provided to communication applications provided by a variety of communication service providers (e.g., email providers, messaging providers, social network providers, financial service providers, marketing service providers, and/or any other communication service providers that allow communication between the merchant, the customer, and/or the system provider).

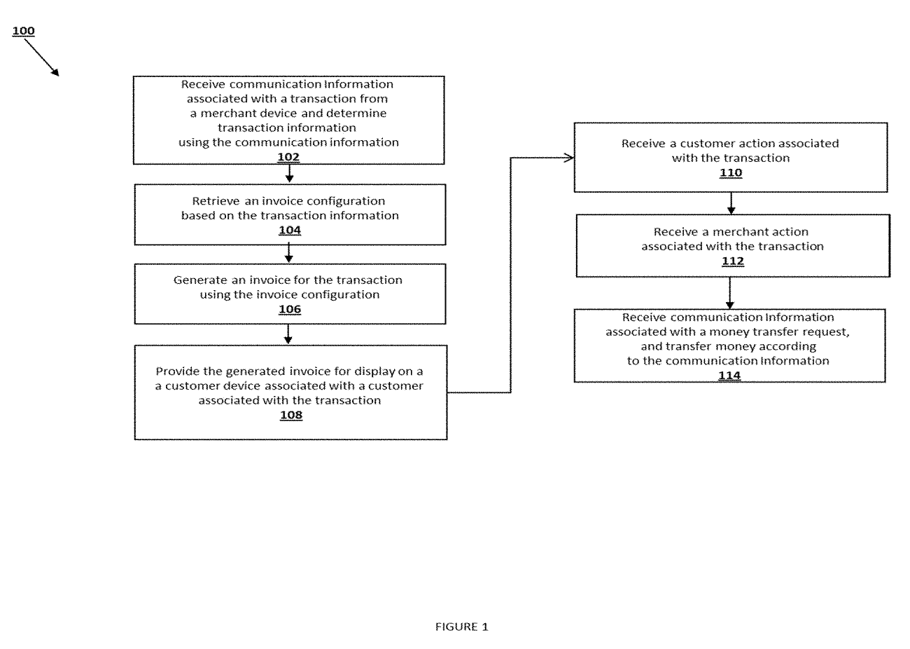

Referring to FIG. 1, an embodiment of a method 100 for providing transaction management is illustrated. In the embodiments discussed below, a payment service provider such as, for example, PayPal, Inc. of San Jose, Calif. is the system provider and operates a system provider device (e.g., payment service provider device) to help the merchants and customers manage transactions including invoice management and payment management. However, one of skill in the art in possession of the present disclosure will recognize that a variety of other system providers such as, for example, marketplace providers, merchants, financial service providers, marketing service providers, and/or other entities will benefit from the teachings herein and thus fall within the scope of the present disclosure.

Referring to FIGS. 1, 2, 3A, and 3B, the method 100 may begin at block 102, where the system provider device receives communication information associated with a transaction from a merchant device, and determines transaction information using the communication information. The communication information may be provided by various communication applications that allow communication between the merchant, the customer, and/or the system provider, for example, an email application, a messaging application, and a calendar application.

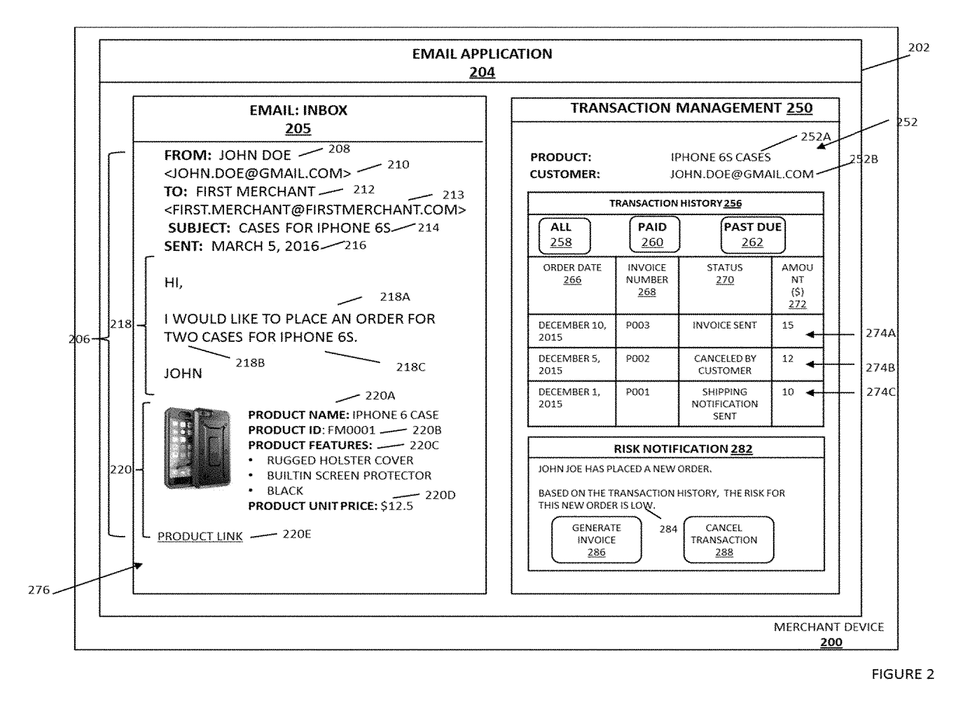

Referring to FIG. 2, illustrated is an example of an email application screen 204 displayed on a display device 202 of a merchant device 200. The email application screen 204 includes an email inbox section 205, where email information 206 associated with a transaction 276 is displayed. While in the example of FIG. 2, a single email is associated with the email information 206, it is understood that the email information 206 may be associated with multiple emails associated with the transaction 276.

The email information 206 may include various information associated with the email, including for example, a sender name 208 (e.g., “JOHN DOE”), a sender email address 210 (e.g., “JOHN.DOE@GMAIL.COM”), a recipient name 212 (e.g., “FIRST MERCHANT”), a recipient email address 213 (e.g., “FIRST.MERCHANT@FIRSTMERCHANT.COM”), an email subject 214 (e.g., “CASES FOR IPHONE 6S”), and a sent date 216 (e.g., “Mar. 5, 2016”). The email information 206 may include a message 218 including a message portion 218A (e.g., “PLACE AN ORDER”) indicating that the sender of the email would like to place an order, a message portion 218B (“TWO”) indicating the quantity of the ordered product, and a message portion 218C (e.g., “CASES FOR IPHONE 6S”) identifying the product that the sender would like to purchase. In some embodiments, the email information 206 further includes product portion 220, which includes a product name 220A (e.g., “IPHONE 6 CASE”), a product identifier 220B (e.g., “FM0001”), product features 220C, a product unit price 220D (e.g., “$12.5”), and a product link 220E linked to a website including details of the product. In some embodiments, the email information 206 further includes sender contact information (e.g., a sender home address) and recipient contact information (e.g., a recipient home address), which may be retrieved from a contacts application integrated with the email application.

In some embodiments, the merchant device 200 sends the communication information including the email information 206 to the system provider device. In some examples, a browser extension or a gadget (e.g., using web technologies such as Hyper Text Markup Language (HTML), JavaScript, and Cascading Style Sheets (CSS)) integrated with the email application 204 is used to send the email information 206 to the system provider device. In some examples, the merchant device 200 sends the email information 206 to the system provider device by forwarding the email information 206 to an email end point (e.g., “createinvoice@paypal.com”) associated with the system provider.

In some embodiments, after receiving the communication information from the merchant device 200, the system provider device determines transaction information associated with the transaction 276 using the communication information, and provides a transaction management section 250 on the email application screen 204 of the merchant device 200 (e.g., by using a browser extension or a gadget). In the embodiment illustrated in FIG. 2, the transaction management section 250 includes transaction information 252 associated with the transaction 276. The transaction information 252 includes product information 252A and customer information 252B determined using the email information 206. In an example, the product information 252A (e.g., “IPHONE 6S CASES”) is determined using the email subject 214, the message portion 218C, and/or the product portion 220 of the email information 206. In another example, the system product provider may use the product name (e.g., “CASES FOR IPHONE 6S”) extracted from the email information 206 to look up the product information 252A in a product catalog associated with the merchant. In some embodiments, the customer information 252B (e.g., “JOHN.DOE@GMAIL.COM”) is determined using the sender name 208, the sender email address 210, and/or the sender contact information of the email information 206.

In some embodiments, the system provider device retrieves a transaction history associated with the customer, the merchant, and/or the product (e.g., from a transaction information database), and provides the transaction history on the transaction history section 256 of the transaction management section 250. In the illustrated example of FIG. 2, the transaction history section 256 includes transaction information for transactions 274A, 274B, and 274C. The transaction information for each of the transactions 274A, 274B, and 274C may include an order date 266, an invoice number 268, a status 270, an amount 272, and any other information associated with a transaction. In an example, the transaction information for the transaction 274A includes an order date 266 (e.g., “Dec. 10, 2015”), an invoice number 268 (e.g., “P003”), a status 270 (e.g., “INVOICE SENT”) indicating that an invoice has sent to the customer, and a transaction amount 272 (e.g., “15”). In another example, the transaction information for the transaction 274B includes an order date 266 (e.g., “Dec. 5, 2015”), an invoice number 268 (e.g., “P002”), a status 270 (e.g., “CANCELED BY CUSTOMER”) indicating that the transaction 274B has been canceled by the customer, and a transaction amount 272 (e.g., “12”). In another example, the transaction information for the transaction 274C includes an order date 266 (e.g., “Dec. 1, 2015”), an invoice number 268 (e.g., “P001”), a status 270 (e.g., “SHIPPING NOTIFICATION SENT”) indicating that the product has been shipped and a shipping notification has been sent to the customer, and a transaction amount 272 (e.g., “10”).

In some embodiments, the merchant may select transaction status buttons 258, 260, 264 to apply a status filter to the transactions displayed in the transaction history section 256. In an example, the merchant selects the transaction status button 258 (e.g., the “ALL” button) so that all transactions between the customer and the merchant are displayed. In another example, the merchant selects the transaction status button 260 (e.g., the “PAID” button), so that the transaction history section 256 displays only the transactions where the customer has made a payment. In another example, the merchant selects the transaction status button 262 (e.g., the “PAST DUE” button), so that the transaction history section 256 displays only the transactions where payments are past due.

In some embodiments, the system provider device analyzes the transaction history to determine a transaction risk associated with the transaction 276, and provides a transaction risk notification in a transaction risk notification section 282 to the merchant. The transaction risk notification section 282 allows the merchant to perform an action associated with the transaction 276 based on the transaction history and/or the transaction risk 284 (e.g., “LOW”). In an example, the merchant selects the “GENERATE INVOICE” button 286 to accept the order and request the system provider device to generate an invoice associated with the transaction 276. In another example, the merchant selects the “CANCEL TRANSACTION” button 288 to cancel the transaction 276 based on the transaction history 256 (e.g., when the number of past due transactions between the customer and the merchant exceeds a threshold of ten) and/or the transaction risk 284 (e.g., when the transaction risk 284 is “HIGH”).

In various embodiments, the transaction management system may be integrated with various communication applications in addition to email applications, for example, messaging applications and calendar applications. Furthermore, the communication information provided by the communication application may be associated with transactions having different transaction types. In an example, the transaction is a group transaction associated with multiple customers. In another example, the transaction is a recurring transaction including a series of repeated individual transactions.

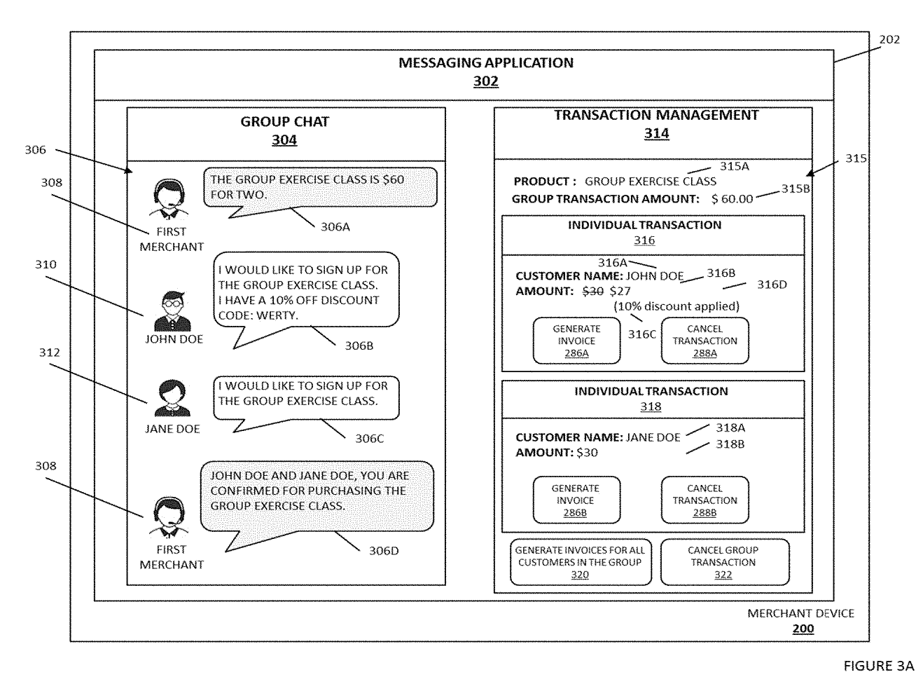

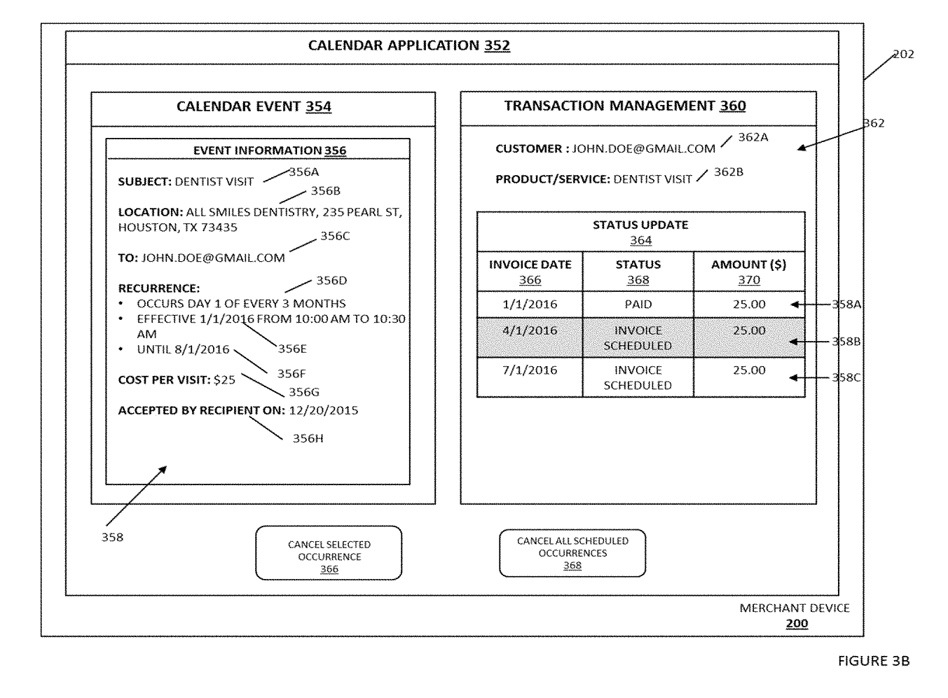

Referring to the example of FIG. 3A, illustrated is an example of a transaction management system integrated with a messaging application that provides communication information associated with a group transaction. Exemplary messaging applications include Short Message Service (SMS) text messaging applications, instant messaging (IM) messaging applications (e.g., SKYPE®, SNAPCHAT®), Multimedia Messaging Service (MMS) message applications, and social networks (e.g., FACEBOOK®, LINKEDLN®, TWITTER®) providing messaging functions. In the embodiment illustrated in FIG. 3A, an example of a messaging application screen 302 is displayed on a display device 202 of a merchant device 200. The messaging application screen 302 includes a group chat section 304 displaying messaging information 306. The messaging information 306 is associated with a group transaction involving a merchant 308 (e.g., “FIRST MERCHANT”), a first customer 310 (e.g., “JOHN DOE”, also referred to as the customer), and a second customer 312 (e.g., “JANE DOE”). The messaging information 306 includes messages 306A and 306D sent by the merchant 308, a message 306B sent by the first customer 310, and a message 306C sent by a second customer 312.

In some embodiments, the merchant device 200 sends communication information including the messaging information 306 associated with the group transaction to the system provider device. After receiving the communication information from the merchant device 200, the system provider device determines group transaction information 315 associated with the group transaction, and provides a transaction management section 314 on the messaging application screen 302 of the merchant device 200 (e.g., by using a browser extension or a gadget). In the embodiment illustrated in FIG. 3A, the group transaction information 315 extracted from the messaging information 306 includes product information 315A (e.g., “GROUP EXERCISE CLASS”) and group transaction amount information 315B (e.g., $ 60.00). In an example, the product information 315A is extracted from the message 306A of the message information 306, and the group transaction amount 315B is extracted from the message 306A of the message information 306.

In some embodiments, the system provider device determines that the group transaction includes a first individual transaction associated with the first customer 310, and a second individual transaction associated with the second customer 312 using the messaging information 306. As illustrated in FIG. 3A, the transaction management section 314 includes the individual transaction information 316 associated with the first individual transaction, which includes customer information 316A (e.g., “JOHN DOE”) extracted from the messaging information 306 (e.g., using the sender information associated with the message 306B), an original individual transaction amount 316B (e.g., “$30”) by splitting the group amount 312B between the first customer 310 and the second customer 312), a discount 316C (e.g., “10% OFF”) extracted from the message 306B, and an individual transaction amount 316D (e.g., “$27”) determined using the original individual transaction amount 316B and the discount 316C.

Similarly, the transaction management section 314 includes individual transaction information 318 associated with the second individual transaction. The individual transaction information 318 includes a customer information 318A (e.g., “JANE DOE”) extracted from the messaging information 306 (e.g., using sender information associated with the message 306C), and an individual transaction amount 318B (e.g., “$30”) by splitting the group transaction amount 312B between the first customer 310 and the second customer 312). In the example illustrated in FIG. 3A, unlike the first individual transaction, no discount is applied to the second individual transaction because the system provider device determines that there is no discount information associated with the second individual transaction (e.g., based on the messaging information 306).

In some embodiments, the transaction management section 314 allows the merchant 308 to perform an action associated with one of the first individual transaction and second individual transaction. In an example, the merchant 308 may select the “GENERATE INVOICE” button 286A to send an invoice generation request to the system provider device for generating an invoice for the first individual transaction. In another example, the merchant 308 may select the “CANCEL TRANSACTION” button 288A to cancel the first individual transaction. Similarly, in another example, the merchant 308 may select the “GENERATE INVOICE” button 286B to send an invoice generation request to the system provider device for generating an invoice for the second individual transaction. In yet another example, the merchant 308 may select the “CANCEL TRANSACTION” button 288B to cancel the second individual transaction.

In some embodiments, the transaction management section 314 allows the merchant 308 to perform a group action associated with the group transaction. In an example, the merchant 308 may select the button 320 to send an invoice generation request to the system provider device for generating invoices for all the individual transactions of the group transaction. In another example, the merchant 308 may select the button 322 to cancel the group transaction.

Referring to the example of FIG. 3B, illustrated is an example of a transaction management system integrated with a calendar application that provides communication information associated with a recurring transaction. Exemplary calendar applications include IBM® Notes and Microsoft® Outlook Calendar. Illustrated in FIG. 3B is an example of a calendar application screen 352 displayed on a display device 202 of a merchant device 200. The calendar application screen 352 includes a calendar event section 354 and a transaction management section 360. As illustrated in FIG. 3B, the calendar event section 354 displays event information 356 associated with a recurring transaction 358. The event information 356 includes subject information 356A (e.g., “DENTIST VISIT”), location information 356B (e.g., “ALL SMILES DENTISTRY, 235 PEARL ST, HOUSTON, Tex. 73435”), recipient email address information 356C (e.g., “JOHN.DOE@GMAIL.COM”), recurrence frequency information 356D (e.g., “OCCURS DAY 1 OF EVEN 3 MONTHS”), recurrence starting date information 356E (e.g., “1/1/2016”), recurrence ending date information 356F (e.g., “8/1/2016”), cost per visit information 356G (e.g., “$25”), and event status information 356H (e.g., “ACCEPTED BY RECIPIENT ON 12/20/2015”).

In some embodiments, the merchant device 200 sends communication information including the event information 356 associated with the recurring transaction to the system provider device. The system provider device determines recurring transaction information 362 associated with the recurring transaction, and provides a transaction management section 314 on the calendar application screen 302 of the merchant device 200 (e.g., by using a browser extension or a gadget). The transaction management section 360 includes the recurring transaction information 362, which includes customer information 362A (e.g., “JOHN.DOE@GMAIL.COM”) determined using the recipient email address 356C of the event information 356, and product/service information 362B (e.g., “DENTIST VISIT”) determined using the subject information 356A. In some embodiments, the system provider device determines that the recurring transaction includes individual transactions 358A, 358B, and 358C using the event information 356. In an example, invoice date information 366 (e.g., “1/1/2016,” “4/1/2016,” “7/1/2016” respectively) of the individual transaction information is determined based on the event information 356 including the recurrence frequency information 356D (e.g., “OCCURS DAY 1 OF EVERY 3 MONTHS”), recurrence starting date information 356E (e.g., “1/1/2016”), and recurrence ending date information 356F (“8/1/2016”). In another example, amount information 370 (e.g., “$25.00”) of the individual transaction information is determined using the cost per visit information 356G of the event information 356.

In some embodiments, the system provider device retrieves the status of the individual transactions 358A, 358B, and 358C (e.g., from a transaction information database) and provides that status in a status update section 364. In an example, the individual transaction 358A has a status (e.g., “PAID”) indicating that the customer has paid an invoice generated for the individual transaction 358A. In another example, the individual transactions 358B and 358C have a status (e.g., “INVOICE SCHEDULED”) indicating that automatically generated invoices are scheduled to be sent to the customer on respective invoice dates 366.

In some embodiments, the calendar application 352 allows the merchant to cancel one or more scheduled individual transactions (e.g., individual transactions having an “INVOICE SCHEDULED” status). In an example, the merchant may select the individual transaction 358B, and select the button 366 to cancel the selected individual transaction 358B. In response, the calendar application removes the occurrence on “4/1/2016” from the event information 356, and the system provider device changes the status of the individual transaction 358B (e.g., from “INVOICE SCHEDULED” to “CANCELED”) and updates the transaction database with the status change. In another example, the merchant may select the button 368 to cancel all the scheduled individual transactions (e.g., individual transactions 358B and 358C) of the recurring transaction 358. In response, the calendar application removes the occurrences on “4/1/2016” and “7/1/2016” from the event information 356, and the system provider device changes the status of the individual transactions 358B and 358C (e.g., from “INVOICE SCHEDULED” to “CANCELED”) and updates the transaction database with the status change.

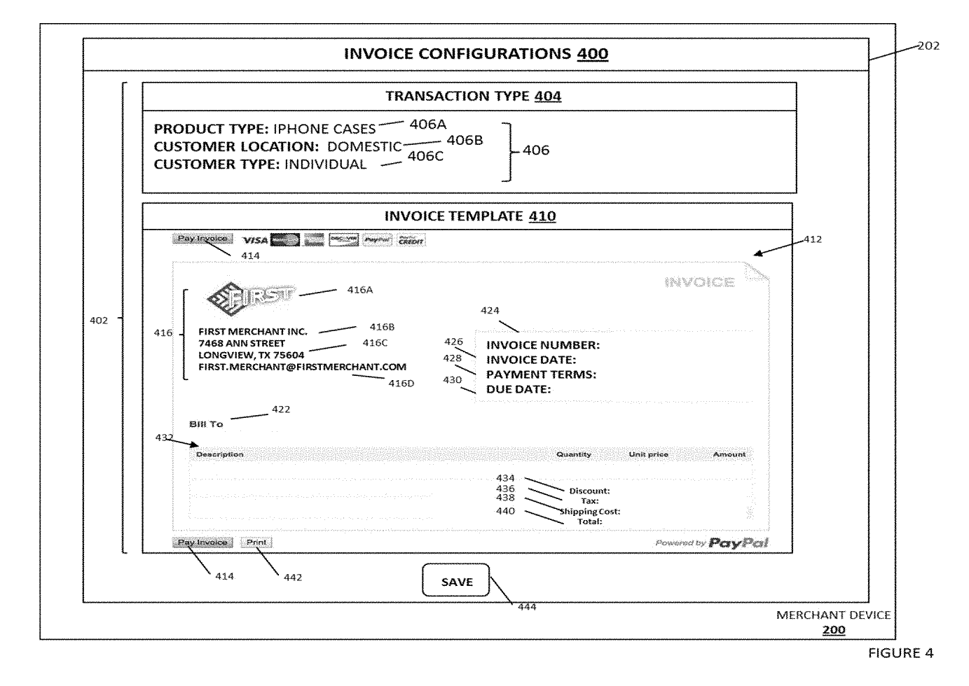

Referring to FIGS. 1 and 4, the method 100 proceeds to block 104, where after receiving an invoice generation request associated with a transaction from a merchant device (e.g., after the merchant selects the “GENERATE INVOICE” button 286 of FIG. 2), the system provider device (or an invoice service provider device providing invoice services) retrieves an invoice configuration (e.g., from an invoice configuration database) for the transaction.

Referring to FIG. 4, illustrated is an example of an invoice configurations screen 400 displayed on a display device 202 of a merchant device 200, which allows the merchant to customize invoice configurations. The invoice configurations screen 400 displays an invoice configuration 402 including a transaction type 406 and an invoice template 412. A transaction type section 404 of the invoice configurations screen 400 allows a merchant to configure the transaction type 406, which includes a product type 406A (e.g., “IPHONE CASES”), a customer location 406B (e.g., “DOMESTIC”), a customer type 406C (e.g., “INDIVIDUAL”), and/or any other transaction type.

In some embodiments, an invoice template section 410 of the invoice configurations screen 400 allows a merchant to configure the invoice template 412 used to generate an invoice associated with a transaction that has a transaction type 406. The invoice template 412 including a “Pay Invoice” button 414, which allows a customer to pay the invoice with various payment methods (e.g., using credit cards, bank accounts). The invoice template 412 includes various sections for the transaction information. In an example, a merchant information section 416 displays merchant information of the transaction information, which includes a merchant logo 416A, a merchant name 416B (“e.g., “First Merchant Inc.”), a merchant address 416C (e.g., “7468 Ann Street, Longview, Tex. 75604”), and a merchant email address 416D (e.g., “FIRST.MERCHANT@FIRSTMERCHANT.COM”). In another example, a bill-to section 422 displays the customer information of the transaction information. In yet another example, a product information table 432 includes columns (e.g., “Description,” “Quantity,” “Unit Price,” “Amount”) to display the product information of the transaction information, including product description information, product quantity information, unit price information, and amount information. The invoice template 412 further includes an invoice number field 424 to include an invoice number, an invoice date field 426 to include an invoice date, a payment terms field 428, a due date field 430, a discount field 434 to display any discount information, a tax field 436 to display tax information, a shipping cost field 438 to display shipping cost information, and a total field 440 to display total amount information. The invoice template 412 also includes a print button 442, which allows a customer to print the invoice.

In some embodiments, after the merchant finishes configuring the invoice configuration 402, the merchant selects the “SAVE” button 444 to save the invoice configuration 402, e.g., in an invoice configuration database.

In some embodiments, after receiving an invoice generation request to generate an invoice for the transaction 276 of FIG. 2, the system provider device determines the transaction type of the transaction 276, and retrieves an invoice configuration (e.g., from an invoice configuration database) based on the determined transaction type. In some embodiments, the transaction type of the transaction 276 is determined using the email information 206. For example, the product type (e.g., “IPHONE CASES”) of the transaction type may be determined using the email subject 214, the customer location (e.g., “DOMESTIC”) of the transaction type may be determined using the sender contact information of the email information 206, and the customer type (e.g., “INDIVIDUAL”) of the transaction type may be determined using the sender name 208 of the email information 206. In some embodiments, the system provider device retrieves the invoice configuration 402 for the transaction 276 after determining that the transaction type 404 of the invoice configuration 402 matches the transaction type of the transaction 276.

In some embodiments where an invoice generation request received by the system provider device is associated with a group transaction including multiple individual transactions, different invoice configurations may be provided to those individual transactions. In an example, the group transaction includes a first individual transaction associated with a first customer who resides within the United States, and a second individual transaction associated with a second customer who resides outside of the United States. As such, a first invoice configuration (e.g., the invoice configuration 402) applicable to domestic transactions is retrieved for the first individual transaction, and will be used to generate a first invoice associated with the first individual transaction for the first customer. On the other hand, a second invoice configuration applicable to international transactions (e.g., including charges and notices associated with international transactions) is retrieved for the second individual transaction, and will be used to generate a second invoice associated with the second individual transaction for the second customer.

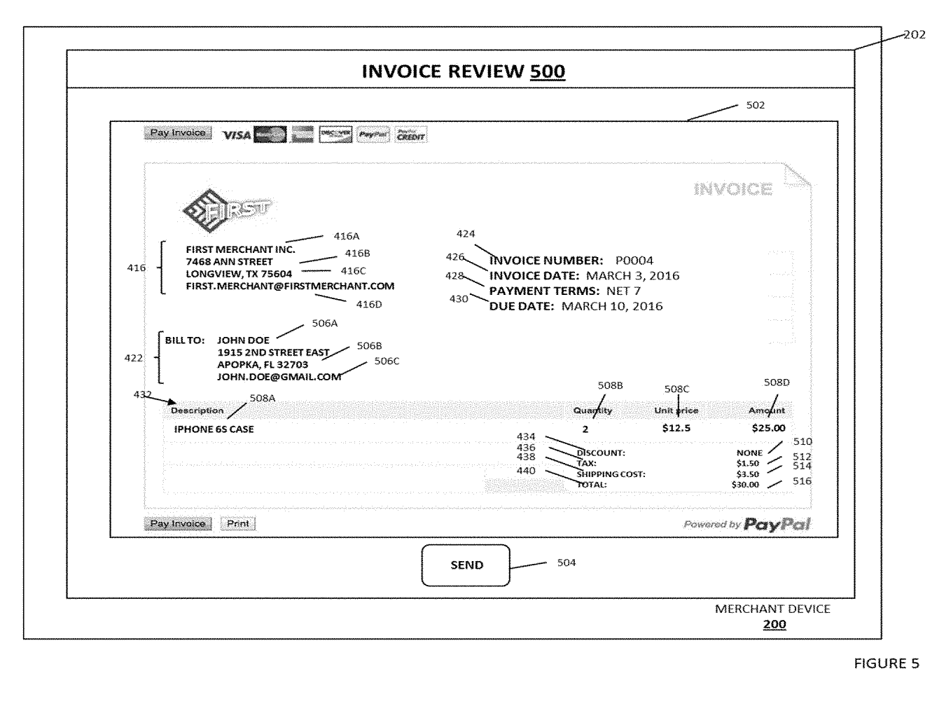

Referring to FIGS. 1 and 5, the method 100 then proceeds to block 106, where an invoice 502 for the transaction 276 is generated using the invoice configuration 402 (e.g., using its invoice template 412) and the email information 206. Referring to the example of FIG. 5, the invoice 502 is displayed on an invoice review screen 500 of a display 202 of the merchant device 200. In some embodiments, the invoice 502 is generated using transaction information determined using the email information 206. In an example, in the bill-to section 422, the customer name information 506A (e.g., “JOHN DOE”) is determined using the sender name 208 of the email information 206, the customer address information 506B (e.g., “1915 2ND STREET EAST, APOPKA, Fla. 32703”) is determined using the sender contact information of the email information 206, and the customer email address information 506C is determined using the sender email address 210 of the email information 206. In another example, in the product information section 432, the product description information 508A (e.g., “IPHONE 6S CASE”) is determined using the email subject 214 of the email information 206, product quantity information 508B (e.g., 2”) is determined using the message portion 218B of the email information 206, unit price information 508C (e.g., “$12.5”) is determined using the production portion 220D of the email information 206, and the amount information 508D (e.g., “$25”) is determined using the product quantity information 508B and unit price information 508C. The discount information 510 (e.g., “NONE”) is determined using the message 218 of the email information 206. The tax information 512 (e.g., “$1.5”) is calculated by multiplying the amount information 508D (e.g., “$25”) and the state sales tax rate (e.g., 6%) for the particular state (e.g., “Fla.”) that the customer resides. The shipping cost information 514 (e.g., “$3.5”) is determined based on a distance between the merchant's address 416B and the customer address information 506B. The total amount information 516 (e.g., “$30”) is determined by combining the amount information 508D, discount information 510, tax information 512, and shipping cost information 514.

In some embodiments, after confirming that the information in the invoice is accurate, the merchant selects the “SEND” button 504 to send the invoice 502 to the customer (e.g., to the customer's email address 422C or to the customer's home address 422B). Alternatively, in some embodiments, the invoice review step is omitted, and the generated invoice is directly sent to the customer.

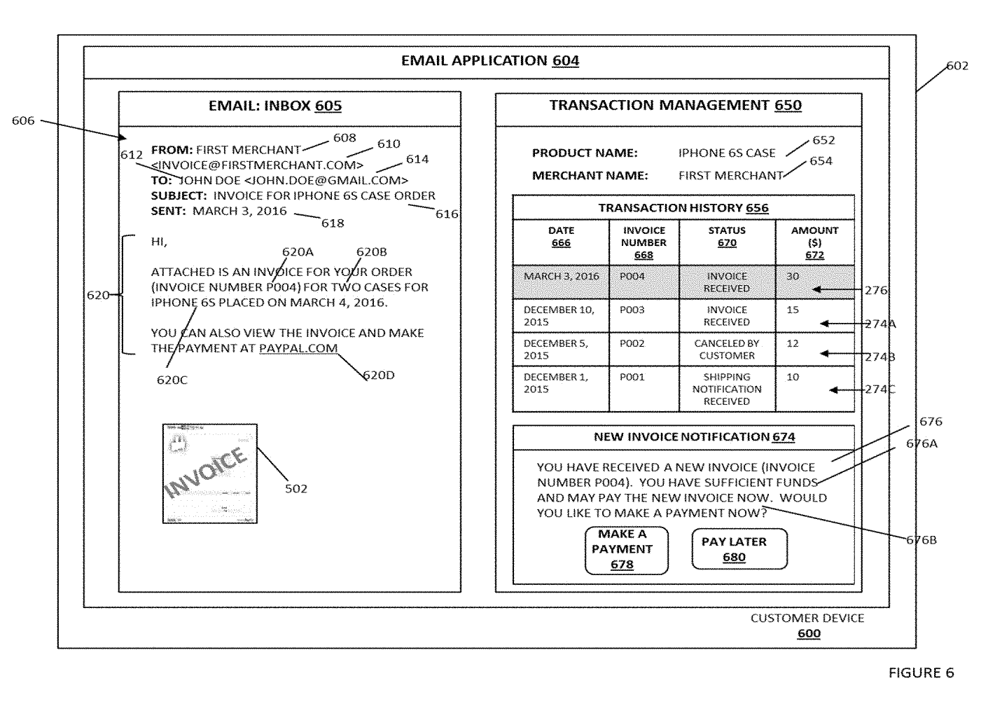

Referring to FIGS. 1 and 6, the method 100 proceeds to block 108, where the invoice 502 is provided for display on a customer device associated with the customer. In some embodiments, the system provider device or the merchant device sends the invoice 502 to the customer by sending an email to an email address associated with the customer. Illustrated in FIG. 6 is an example of an email application screen 604 displayed on a display device 602 of a customer device 600. The email application screen 604 includes an email inbox section 605 displaying email information 606 associated with an email sent by the merchant to the customer associated with the transaction 276. The email information 606 includes a sender name 608 (e.g., “FIRST MERCHANT”), a sender email address 610 (e.g., “INVOICE@FIRSTMERCHANT.COM”), a recipient name 612 (e.g., “JOHN DOE”), a recipient email address 614 (e.g., “JOHN.DOE@GMAIL.COM”), an email subject 616 (e.g., “INVOICE FOR IPHONE 6S CASE ORDER”), a sent date 618 (e.g., “Mar. 3, 2016”). The email information 606 further includes a message 620 including a message portion 620A (e.g., “P004”) providing the invoice number, a message portion 620B (“TWO”) providing the quantity information, and a message portion 620C (e.g., “CASES FOR IPHONE 6S”) providing the product name. In some embodiments, the email information 606 further includes a payment service link 620D (e.g., “PAYPAL.COM”), which links to a payment service website where the customer may review the invoice, make a payment, and perform other actions associated with the transaction 276. An invoice 502 may be attached in the email as well.

In some embodiments, the customer device 600 sends communication information including the email information 606 to the system provider device. The system provider device determines transaction information (e.g., product name information 652, merchant name information 654) associated with the transaction 276 using the email information 606, and provides a transaction management section 650 (e.g., using a widget) on the email application screen 604 of the customer device 600. In an example, the product name information 652 (e.g., “IPHONE 6S CASE”) is determined using the email subject information 616 of the email information 606. In another example, the merchant name information 654 (e.g., “FIRST MERCHANT”) of the transaction information is determined using the sender name 608 of the email information 606.

In some embodiments, the system provider device retrieves transaction history associated with the customer, the merchant, and/or the product, and displays the transaction history in a transaction history section 656. In an example, the transaction history section 656 includes transaction information associated with the transaction 276 associated with the received invoice 502 and previous transactions 274A, 274B, 274C between the merchant and the customer. The transaction 275 has a status 670 (e.g., “INVOICE RECEIVED”) indicating that the customer has receive an invoice associated with the transaction 276.

In some embodiments, the transaction history section 656 includes transaction information for transactions 274A, 274B, and 274C. The transaction information for each of the transactions 274A, 274B, and 274C may include an order date 666, an invoice number 668, a status 670, and an amount 672. In an example, the transaction information for the transaction 274A includes an order date 666 (e.g., “Dec. 10, 2015”), an invoice number 668 (e.g., “P003”), a status 670 (e.g., “INVOICE RECEIVED”) indicating that an invoice has been received by the customer, and a transaction amount 272 (e.g., “15”). In another example, the transaction information for the transaction 274B includes an order date 666 (e.g., “Dec. 5, 2015”), an invoice number 668 (e.g., “P002”), a status 670 (e.g., “CANCELED BY CUSTOMER”) indicating that the transaction 274B has been canceled by the customer, and a transaction amount 672 (e.g., “12”). In another example, the transaction information for the transaction 274C includes an order date 666 (e.g., “Dec. 1, 2015”), an invoice number 668 (e.g., “P001”), a status 670 (e.g., “SHIPPING NOTIFICATION SENT”) indicating that the product has been shipped and a shipping notification has been sent to the customer, and a transaction amount 672 (e.g., “10”).

In some embodiments, the system provider device reviews the customer's financial status, determines whether the customer has sufficient funds to pay the invoice 502 (e.g., based on an account balance of a bank account of the customer), and provides a new invoice notification to the customer in the new invoice notification section 674. The new invoice notification section 674 includes a notification message 676 including a financial status 676A (e.g., “YOU HAVE SUFFICIENT FUNDS”) and a payment recommendation 676B (e.g., “PAY THE NEW INVOICE NOW”), and provides buttons 678 and 680 so that the customer may perform a customer action associated with the transaction 276.

Referring to FIGS. 1, 6, and 7, the method 100 then proceeds to block 110, where a customer action associated with the transaction is received by the system provider device. In some embodiments, as illustrated in the example of FIG. 6, after receiving the new invoice notification message 676, the customer may choose the “MAKE A PAYMENT” button 678 to pay the invoice 502 associated with the transaction 276. Alternatively, the customer may choose the “PAY LATER” button 680 without making a payment for the invoice 502 immediately.

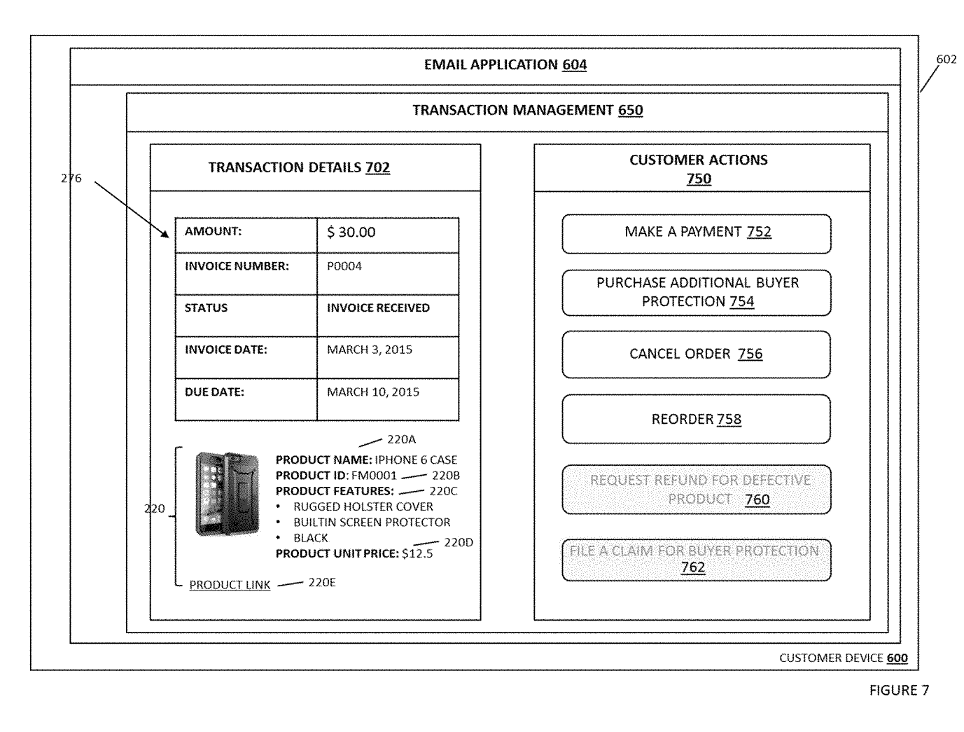

Referring to FIG. 7, in some embodiments, the transaction management system provides the customer the convenience of managing transactions inside the email application screen 604 by allowing the customer to perform various customer actions associated with the transactions in the email application screen 604. The system provider device determines available customer actions associated with a particular transaction (e.g., based on the status of the transaction, the type of the transaction, and/or the financial status of the customer), and provides the available customer actions in the email application screen 604 on the customer device 600. Illustrated in FIG. 7 is an example of a transaction management section 650 displayed on an email application screen 604 displayed on a display device 602 of a customer device 600. The transaction management section 650 includes a transaction details section 702 and a customer actions section 750 for reviewing details of a transaction and performing customer actions for the transaction. While the example of FIG. 7 illustrates that the transaction details section 702 and a customer actions section 750 are associated with the new transaction 276, it is noted that the transaction details section 702 and a customer actions section 750 may be associated with any transaction (e.g., transactions 274A, 274B, and/or 274C) associated with the customer.

The transaction management section 650 includes a customer actions section 750 providing customer actions associated with the transaction 276 that the customer may perform. Whether a particular customer action is available is determined by the system provider device based on the status of the transaction, the type of the transaction, the financial status of the customer, and/or other information associated with the merchant, the customer, and/or the transaction. In an example, the “MAKE A PAYMENT” button 752 is available after the system provider device determines that the customer has not made a payment for the transaction 276, and that the customer has sufficient funds to pay the amount of the transaction 276. In another example, the “PURCHASE ADDITIONAL BUYER PROTECTION” button 754 is available after the system provider device determines that the transaction is associated with a product, and additional buy protection for the transaction is available. In another example, the “CANCEL ORDER” button 756 is available after the system provider device determines that the transaction 276 is not a final sale and that the merchant allows cancelling the transaction 276. In another example, the “REORDER” button 758 is available after the system provider device determines that the product is in stock at the merchant. In another example, the “REQUEST REFUND FOR RETURNED PRODUCT” button 760 is not available after the system provider device determines that the customer has not paid the invoice 502 and/or the product has not been shipped to the customer. In another example, the “FILE A CLAIM FOR BUYER PROTECTION” button 762 is not available after the system provider device determines that the customer has not made a payment for the transaction.

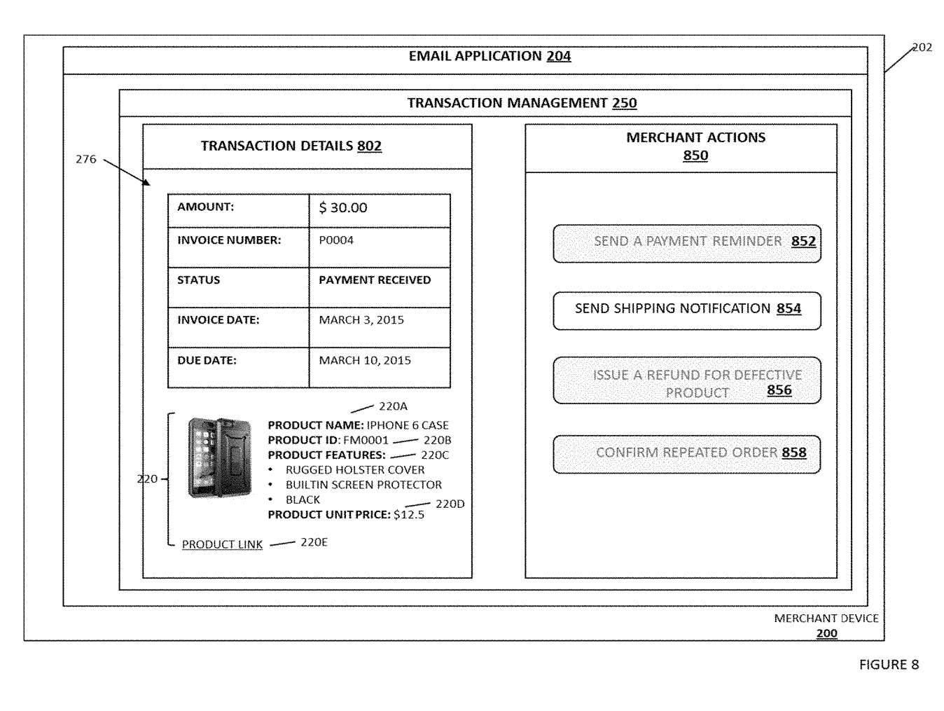

Referring to FIGS. 1 and 8, the method 100 then proceeds block 112, where a merchant action associated with a transaction is received by the system provider device. In various embodiments, the transaction management system allows the merchant to perform various merchant actions for transactions in the email application screen 204. In various embodiments, the system provider device determines available merchant actions associated with a particular transaction (e.g., based on the status of the particular transaction, the type of the particular transaction, and/or the customer action associated with the particular transaction), and provides the available merchant actions in the email application screen 204 on the merchant device 200. Illustrated in FIG. 8 is an example of a transaction management section 250 displayed on an email application screen 204 displayed on a display device 202 of a merchant device 200. The transaction management section 250 includes a transaction details section 802 displaying various transaction information associated with the transaction 276. In the example illustrated in FIG. 7, the customer has paid the invoice 502 for the transaction 276 (e.g., by choosing the “MAKE A PAYMENT” button 752 of FIG. 7), and the transaction 276 has a status of “PAYMENT RECEIVED.”

The transaction management section 250 includes a merchant actions section 850 providing merchant actions associated with the transaction 276. Whether a particular merchant action is available for the transaction 276 is determined by the system provider device based on the status of the transaction, the type of the transaction, and/or other information associated with the merchant, the customer, and/or the transaction. In an example, the “SEND A PAYMENT REMINDER” button 852 is not available after the system provider device determines that the customer has already made a payment for the transaction 276 and that no payment reminder is necessary. In another example, the “SEND SHIPPING NOTIFICATION” button 854 is available after the system provider device determines that the transaction 276 is associated with a product, that the customer has made a payment for the transaction 276, and that the merchant has not sent a shipping notification to the customer. The merchant may choose the “SEND SHIPPING NOTIFICATION” button 854 after the product has been shipped to the customer. In the example illustrated in FIG. 8, the “ISSUE A REFUND FOR DEFECTIVE PRODUCT” button 856 is not available after the system provider device determines that the merchant has not shipped the product to the customer. Alternatively, in some examples, after the system provider device determines that the customer has performed a customer action 760 to request a refund for a defective product, the “ISSUE A REFUND FOR DEFECTIVE PRODUCT” button 856 is available to allow the merchant to issue a refund to the customer. In the example illustrated in FIG. 8, the “CONFIRM REPEATED ORDER” button 858 is not available after the system provider device determines that the customer has not performed a customer action 758 to order the product again. Alternatively, in some examples, after the system provider device determines that the customer has performed a customer action 758 to reorder the product, the button 858 is enabled to allow the merchant to confirm the repeated order placed by the customer.

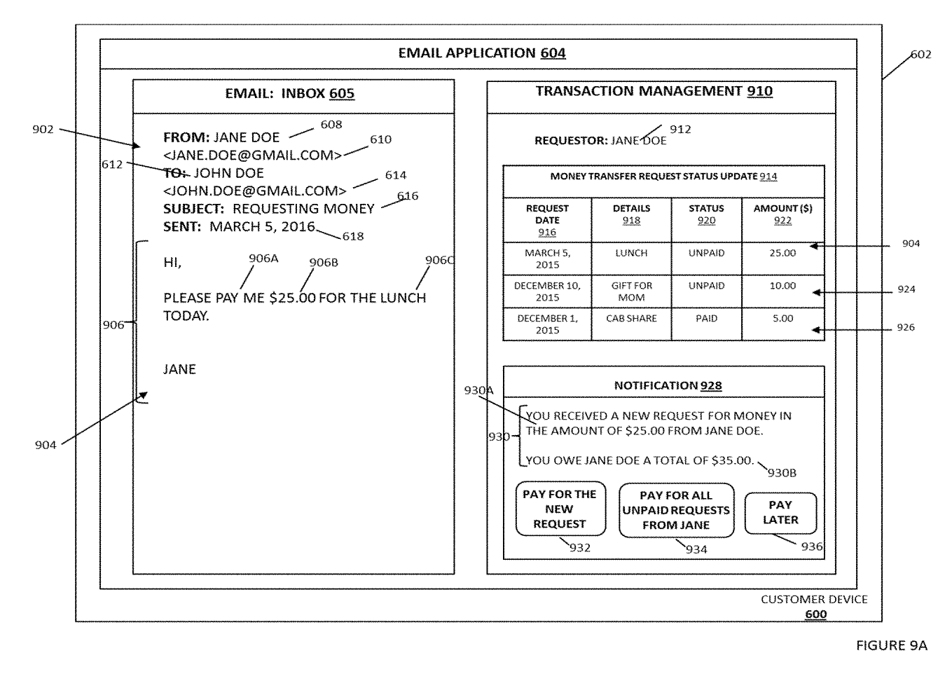

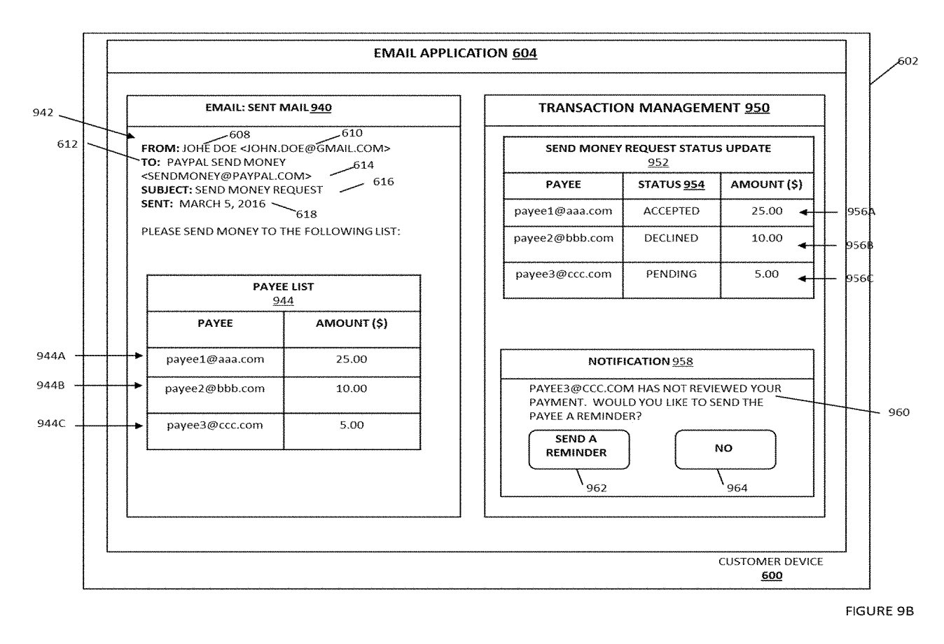

Referring to FIGS. 1, 9A, and 9B, the method 100 proceeds to block 114, where the system provider device receives communication information associated with a transaction that is not associated with products/services purchased from merchants. For example, the transaction includes a money transfer request to send money or request money between family and friends. For such transactions, the system provider device may not provide any buyer protection.

Referring to the examples of FIG. 9A, in some embodiments, a first customer communicates directly with a second customer regarding a money transfer request, for example, by sending an email to an email address associated with the second customer. Illustrated in FIG. 9A is an example of an email application screen 604 displayed on a display device 602 of a customer device 600. The email application screen 604 includes an email inbox section 605 displaying email information 902 associated with an email sent by the second customer 312 to the first customer 310. The email information 902 includes a sender name 608 (e.g., “JANE DOE”), a sender email address 610 (e.g., “JANE.DOE@GMAIL.COM”), a recipient name 612 (e.g., “JOHN DOE”), a recipient email address 614 (e.g., “JOHN.DOE@GMAIL.COM”), an email subject 616 (e.g.,

“REQUESTING MONEY”), and a sent date 618 (e.g., “Mar. 5, 2016”). The email information 902 further includes a message 906 including a message portion 906A (e.g., “PAY ME”) identifying the money transfer type (e.g., requesting money), a message portion 906B (e.g., “$25.00”) identifying the amount for the requested payment, and a message portion 906C (e.g., “LUNCH TODAY”) providing the details of an event associated with the requested payment.

In some embodiments, the customer device 600 sends communication information including the email information 902 to the system provider device. The system provider device determines money transfer request information associated with the money transfer request 904 using the email information 902, and provides a transaction management section 910 (e.g., using a widget) on the email application screen 604 of the customer device 600. For example, the transaction manager section 910 may display the requestor name 912 (e.g., “JANE DOE”) of the money transfer request information, which is determined using the sender name 608 of the email information 902.

In some embodiments, the system provider device retrieves all or some of money transfer requests where the second customer 312 requests money from the first customer 310 (e.g., from a transaction database), and displays money transfer request information associated with these money transfer requests in the money transfer request status update section 914. In the example of FIG. 9A, the money transfer request status update section 914 includes money transfer request information associated with money transfer request 904, which includes request date information 916 (e.g., “Mar. 5, 2015”) determined using the sent field 618 of the email information 902, details information 918 (e.g., “LUNCH”) determined using the message portion 906C of the email information 902, and amount information 922 (e.g., “$25.00”) determined using the message portion 906B of the email information 902. The money transfer request information associated with the money transfer request 904 also includes status information 920 (e.g., “UNPAID”) indicating that the first customer 310 has not paid the requested amount associated with the money transfer request 904.

In some embodiments, the money transfer requests status update section 914 include money transfer request history including money transfer requests 924 and 926 sent by the second customer 312 to the first customer 310. In an example, the money transfer request information associated with the money transfer request 924 includes request date information 916 (e.g., “Dec. 10, 2015”) providing the time that the money transfer request was made, details information 918 (e.g., “GIFT FOR MOM”), status information 920 (e.g., “UNPAID”) indicating that the first customer 310 has not transferred money to the second customer 312 in response to the money transfer request, and an amount 922 (e.g., “10.00”) indicating the amount of the money transfer request. In another example, the money transfer request information associated with the money transfer request 926 includes request date information 916 (e.g., “Dec. 1, 2015”) providing the time that the money transfer request was made, details information 918 (e.g., “CAB SHARE”), status information 920 (e.g., “PAID”) indicating that the requested amount has been transferred from the first customer 310 to the second customer 312 in response to the money transfer request 926, and an amount 922 (e.g., “5.00”) indicating the amount of the money transfer request.

In some embodiments, the system provider device provides a new money transfer request notification to the first customer 310 in a notification section 928. The new money transfer request notification includes a notification message 930 notifying the first customer 310 about the money transfer request associated with the email information 902. The notification message 930 may include an amount 930A (e.g., “$25.00”) of the money transfer request. The notification message 903 may further include a total unpaid balance 930B (e.g., “$35.00”) that the first customer 310 owes the second customer 312 (e.g., by adding the amounts of unpaid transfer money requests 904 and 926). In an example, the first customer 310 may choose the “PAY FOR THE NEW REQUEST” button 932 to pay the amount (e.g., “$25.00”) associated with the money transfer request 904. In another example, the first customer 310 may choose the “PAY FOR ALL UNPAID REQUESTS FROM JANE” button 934 to pay the amount (e.g., “$35.00”) associated with the money transfer requests 904 and 924. In yet another example, the first customer 310 may choose the “PAY LATER” button 936 without making a payment for any money transfer request from immediately.

Referring to FIG. 9B, in some embodiments, a customer communicates directly with the system provider regarding a money transfer request, for example, by sending an email to a system provider email address provided by the system provider. In some examples, the money transfer request is a group money transfer request to request money from multiple payors. Alternatively, in some examples, the money transfer request is a group money transfer request to send money to multiple payees (also referred to as a mass send money request), which is illustrated in the example of FIG. 9B. Illustrated in FIG. 9B is an example of an email application screen 604 displayed on a display device 602 of a customer device 600 associated with the customer. The email application screen 604 includes a sent mail section 940 and a transaction management section 950. The sent mail section 940 displays email information 942 associated with a mass send money request sent by the customer to the system provider device. The email information 942 includes a sender name 608 (e.g., “JOHN DOE”), a sender email address 610 (e.g., “JOHN.DOE@GMAIL.COM”), a recipient name 612 (e.g., “PAYPAL SEND MONEY”), a recipient email address 614 (e.g., “SENDMONEY@PAYPAL.COM”), an email subject 616 (e.g., “SEND MONEY REQUEST”), and a sent date 618 (e.g., “Mar. 5, 2016”). The email information 942 further includes a payee list 944, which includes payee information 944A providing that an amount of $25.00 is to be sent to a payee at “payee1@aaa.com,” payee information 944B providing that an amount of $10.00 is to be sent to a payee at “payee2@bbb.com,” and payee information 944C providing that an amount of $5.00 is to be sent to a payee at payee3@ccc.com.

In some embodiments, the customer device 600 sends communication information including the email information 942 to the system provider device. The system provider device determines mass send money request information associated with the email information 942 (e.g., using the payee list 944), sends money to the payees according to the mass send money request information, and provides a transaction management section 950 (e.g., using a widget) on the email application screen 604 of the customer device 600. In the embodiment illustrated in FIG. 9B, the transaction manager section 950 includes a send money request status update section 952 displaying the status of the mass send money request in a status update section 952. The mass send money request includes individual send money requests 956A, 956B, and 956C corresponding to the payee information 944A, 944B, and 944C respectively. A status of each individual send money request is retrieved (e.g., from a transaction database) and provided in the send money request status update section 952. In an example, the individual send money request 956A has a status 954 (e.g., “ACCEPTED”) indicating that the payee (e.g., “payee1@aaa.com”) has already accepted the customer's payment of $25.00. In another example, the individual send money request 944B has a status 954 (e.g., “DECLINED”) indicating that the payee (e.g., “payee2@bbb.com”) has declined the customer's payment of $10.00. In another example, the individual send money request 944C has a status “PENDING” indicating that the payee (e.g., “payee3@ccc.com”) has not reviewed the customer's payment of $5.00 to the payee.

In some embodiments, the system provider device provides a notification to the customer based on the status of the mass send money request in a notification section 954. In the example of FIG. 9B, the notification section 954 includes a notification message 956 providing a notification associated with the individual money transfer request 956C where the payee has not reviewed the customer's payment. The customer may choose the “SEND A REMINDER” button 958 to send the payee (e.g., “payee3@ccc.com”) a notification (e.g., through a call, an email) to remind the payee to review the payment. Alternatively, the customer may choose the “NO” button 960 to not send a reminder to the payee.

The examples illustrated in FIGS. 9A and 9B are not intended to be limiting. Communication information associated with money transfer requests (e.g., for sending money or requesting money) of various types may be provided. In an example, calendar event information provided by a calendar application may be associated with a recurring money transfer request (e.g., for sending money or requesting money), and multiple individual money transfer transactions may be scheduled according to the calendar event information. Furthermore, the notification may be provided to the customer device in a variety of manners (through a website, an application, as a message (e.g., an email, a text message, a picture message, a “pop-up”, a voice call, etc.) without departing from the scope of the present disclosure.

Thus, systems and methods for providing transaction management integrated with communication applications have been described that operate to provide merchants and customers a transaction management system for managing various transactions using communication information provided by communication applications. For an order placed using a communication application, the systems and methods allow automatic invoice generation for the transaction using the communication information, which simplifies the transaction reduces human error. Furthermore, the systems and methods may provide the merchants and customers the convenience of managing transactions in a communication application by allowing merchants and/or customers to perform various actions for the transaction in the communication application. For example, the merchants and/or customers may review transaction history in the communication application, and perform an action for the transaction based on the transaction history.

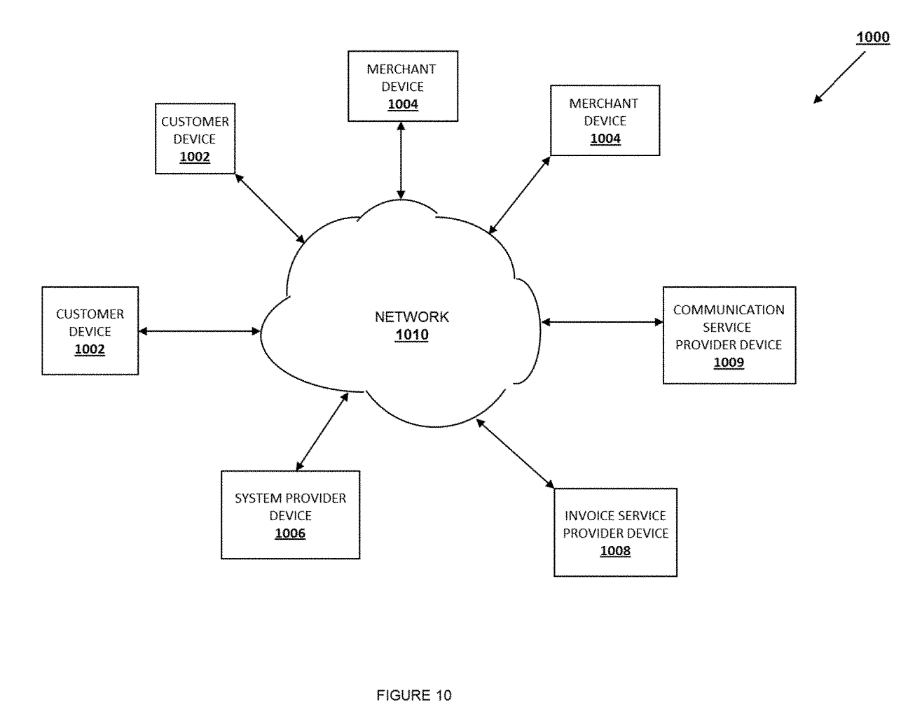

Referring now to FIG. 10, an embodiment of a network-based system 1000 for implementing one or more processes described herein is illustrated. As shown, network-based system 1000 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 10 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 1000 illustrated in FIG. 10 includes a plurality of customer devices 1002, a plurality of merchant devices 1004, a system provider device 1006, an invoice service provider device 1008, and a communication service provider device 1009 in communication over a network 1010. Any of the customer devices 1002 may be the customer devices 600 discussed above and used by the customer discussed above. Any of the merchant devices 1004 may be the merchant device 200 discussed above. Any of the invoice service provider device 1008 may be the invoice service provider device 1008 discussed above. The communication service provider device 1009 may provide the communication applications discussed above. The system provider device 1006 may be the system provider device discussed above and may be operated by a system provider such as, for example, PayPal Inc. of San Jose, Calif.

The customer devices 1002, merchant devices 1004, system provider devices 1006, invoice service provider device 1008, and communication service provider device 1009 may each include one or more hardware processors, non-transitory memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 1000, and/or accessible over the network 1010.

The network 1010 may be implemented as a single network or a combination of multiple networks. For example, in various embodiments, the network 1010 may include the Internet and/or one or more intranets, landline networks, wireless networks, and/or other appropriate types of networks.

The customer device 1002 may be implemented using any appropriate combination of hardware and/or software configured for wired and/or wireless communication over network 1010. For example, in one embodiment, the customer device 1002 may be implemented as a personal computer of a user in communication with the Internet. In some embodiments, the customer device 1002 may be a wearable device. In some embodiments, the customer device 1002 may be a smart phone, personal digital assistant (PDA), laptop computer, and/or other types of computing devices.

The customer device 1002 may include one or more browser applications which may be used, for example, to provide a convenient interface to permit the customer to browse information available over the network 1010. For example, in one embodiment, the browser application may be implemented as a web browser configured to view information available over the Internet.

The customer device 1002 may also include one or more toolbar applications which may be used, for example, to provide user-side processing for performing desired tasks in response to operations selected by the customer. In one embodiment, the toolbar application may display a user interface in connection with the browser application.

The customer device 1002 may further include other applications as may be desired in particular embodiments to provide desired features to the customer device 1002. The other applications may also include security applications for implementing user-side security features, programmatic user applications for interfacing with appropriate application programming interfaces (APIs) over the network 1010, or other types of applications. Email and/or text applications may also be included, which allow the customer to send and receive emails and/or text messages through the network 1010. The customer device 1002 includes one or more user and/or device identifiers which may be implemented, for example, as operating system registry entries, cookies associated with the browser application, identifiers associated with hardware of the customer device 1002, or other appropriate identifiers, such as a phone number. In one embodiment, the customer identifier may be used by the system provider device 1006 to associate the customer with a particular account as further described herein.

In some embodiments, the merchant devices 1004 are substantially similar to the customer device 1002 described above. The merchant devices 1004 may be maintained, for example, by a conventional or on-line merchant, conventional or digital goods seller, individual seller, and/or application developer offering various products and/or services in exchange for payment to be received conventionally or over the network 1010. In this regard, the merchant devices 1004 may include a database identifying available products and/or services (e.g., collectively referred to as items) which may be made available for viewing and purchase by the customers.

The merchant devices 1004 also include a checkout application which may be configured to facilitate the purchase by the customers. The checkout application may be configured to accept payment information from the customer through the customer devices 1002, from the system provider through the system provider device 1006, and/or other system providers over the network 1010.

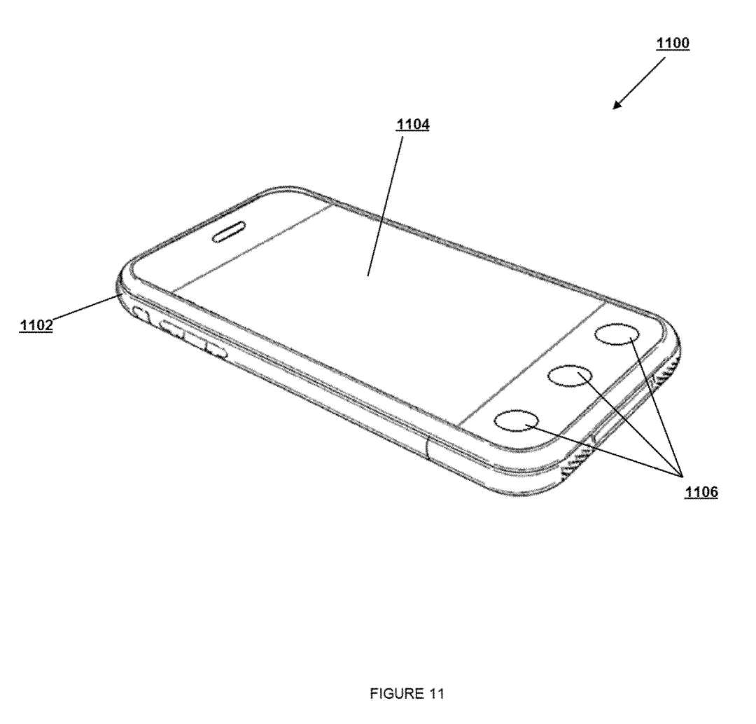

Referring now to FIG. 11, an embodiment of a customer device 1100 is illustrated. The customer device 1100 may be the customer devices 600. The customer device 1100 includes a chassis 1102 having a display 1104 and an input device including the display 1104 and a plurality of input buttons 1106. One of skill in the art will recognize that the customer device 1100 is a portable or mobile phone including a touch screen input device and a plurality of input buttons that allow the functionality discussed above with reference to the method 100. However, a variety of other portable/mobile customer devices may be used in the method 100 without departing from the scope of the present disclosure.

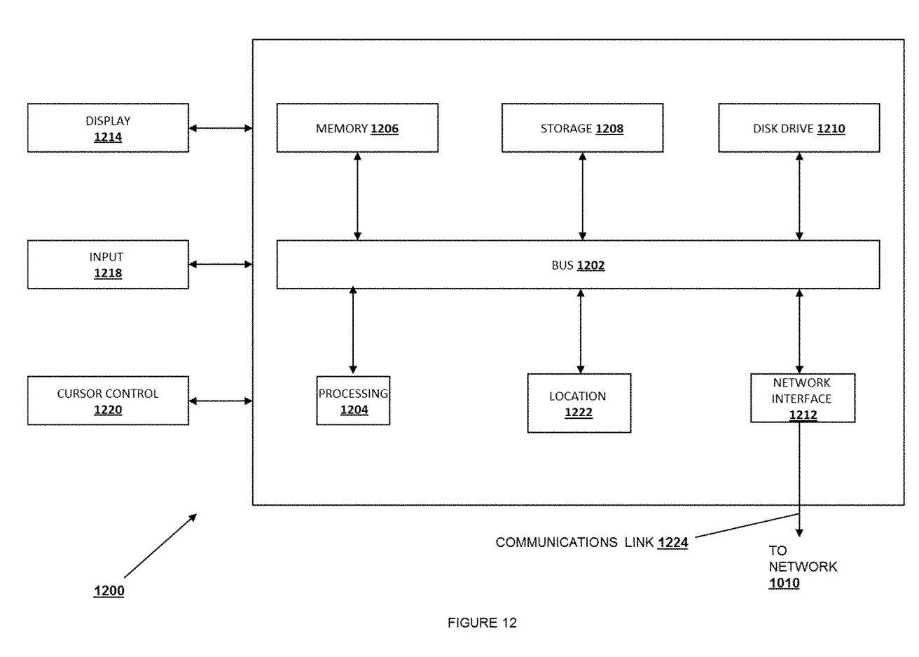

Referring now to FIG. 12, an embodiment of a computer system 1200 suitable for implementing, for example, the system provider devices, merchant devices 200, and/or customer devices 600, is illustrated. It should be appreciated that other devices utilized by users, persons, and/or system providers in the system discussed above may be implemented as the computer system 1200 in a manner as follows.

In accordance with various embodiments of the present disclosure, computer system 1200, such as a computer and/or a network server, includes a bus 1202 or other communication mechanism for communicating information, which interconnects subsystems and components, such as a processing component 1204 (e.g., hardware processor, micro-controller, digital signal processor (DSP), etc.), a system memory component 1206 (e.g., RAM), a static storage component 1208 (e.g., ROM), a disk drive component 1210 (e.g., magnetic or optical), a network interface component 1212 (e.g., modem or Ethernet card), a display component 1214 (e.g., CRT or LCD), an input component 1218 (e.g., keyboard, keypad, or virtual keyboard), a cursor control component 1220 (e.g., mouse, pointer, or trackball), and a location sensor component 1222 (e.g., a Global Positioning System (GPS) device as illustrated, a cell tower triangulation device, and/or a variety of other location determination devices). In one implementation, the disk drive component 1210 may comprise a database having one or more disk drive components.

In accordance with embodiments of the present disclosure, the computer system 1200 performs specific operations by the processor 1204 executing one or more sequences of instructions contained in the memory component 1206, such as described herein with respect to the customer device(s) 200, the merchant devices 200, and/or the system provider device(s). Such instructions may be read into the system memory component 1206 from another computer readable medium, such as the static storage component 1208 or the disk drive component 1210. In other embodiments, hard-wired circuitry may be used in place of or in combination with software instructions to implement the present disclosure.

Logic may be encoded in a computer readable medium, which may refer to any medium that participates in providing instructions to the processor 1204 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1210, volatile media includes dynamic memory, such as the system memory component 1206, and transmission media includes coaxial cables, copper wire, and fiber optics, including wires that comprise the bus 1202. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 1200. In various other embodiments of the present disclosure, a plurality of the computer systems 1200 coupled by a communication link 1224 to the network 1010 (e.g., such as a LAN, WLAN, PTSN, and/or various other wired or wireless networks, including telecommunications, mobile, and cellular phone networks) may perform instruction sequences to practice the present disclosure in coordination with one another.

The computer system 1200 may transmit and receive messages, data, information and instructions, including one or more programs (i.e., application code) through the communication link 1224 and the network interface component 1212. The network interface component 1212 may include an antenna, either separate or integrated, to enable transmission and reception via the communication link 1224. Received program code may be executed by processor 1204 as received and/or stored in disk drive component 1210 or some other non-volatile storage component for execution.

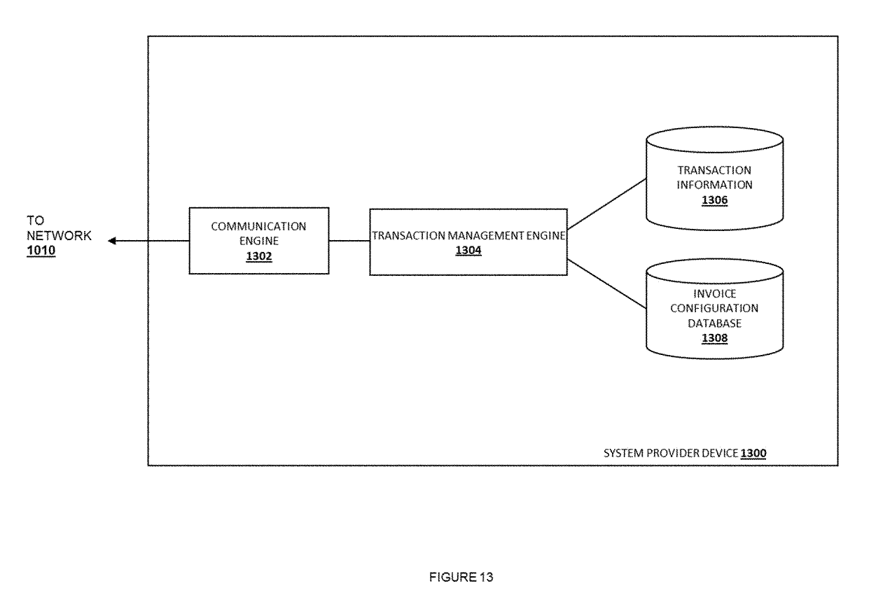

Referring now to FIG. 13, an embodiment of a system provider device 1300 is illustrated. In an embodiment, the system provider device 1300 may be the system provider devices discussed above. The system provider device 1300 includes a communication engine 1302 that is coupled to the network 1010 and to a transaction management engine 1304 that is coupled to a transaction information database 1306 and an invoice configuration database 1308. In an embodiment, the transaction information database 1306 may be the transaction information database discussed above, and the invoice configuration database 1308 may be the invoice configuration database discussed above. The communication engine 1302 may be software or instructions stored on a computer-readable medium that allows the system provider device 1300 to send and receive information over the network 1010. The transaction management engine 1304 may be software or instructions stored on a computer-readable medium that is operable to receive communication information associated with a transaction provided by a communication application, determine transaction information associated with the transaction using the communication information, retrieve an invoice configuration associated with the transaction, generate an invoice associated for the transaction using the invoice configuration, providing the invoice for display on a customer device, and provide any of the other functionality that is discussed above. While the databases 1306 and 1308 have been illustrated as separate from each other and located in the system provider device 1300, one of skill in the art will recognize that any or all of the databases 1306 and 1308 may be combined and/or may be connected to the transaction management engine 1304 through the network 1010 without departing from the scope of the present disclosure.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

1. An invoice management system, comprising:
at least one database storing one or more invoice configurations that are associated with a merchant;
a non-transitory memory; and
one or more hardware processors coupled to the non-transitory memory and configured to execute instructions from the non-transitory memory to cause the system to perform operations comprising:
receiving an electronic communication from a merchant device corresponding to a transaction;
determining a transaction type corresponding to the transaction by analyzing content of the electronic communication;
responsive to the determining the transaction type corresponding to the transaction, accessing the at least one database to automatically identify a first invoice configuration of the one or more invoice configurations that corresponds to the determined transaction type; and
generating a first invoice for a first customer associated with the transaction using the first invoice configuration, wherein generating the first invoice includes:
analyzing the content of the communication to determine invoice information corresponding to the transaction; and
populating the first invoice with the determined invoice information.

2. The system of claim 1, wherein the operations further comprise:
communicating the first invoice to a device of the first customer, wherein the communicating the first invoice causes a selectable option corresponding to one or more invoice actions to be displayed on the device of the first customer.

3. The system of claim 1, wherein the operations further comprise:
determining that a second customer is associated with the transaction based on analyzing the content of the electronic communication;
responsive to the determining the transaction type corresponding to the transaction, accessing the at least one database to automatically identify a second invoice configuration of the one or more invoice configurations that corresponds to the determined transaction type and information associated with the second customer;
generating a second invoice using the second invoice configuration; and
communicating the second invoice over the network that causes a display of the second invoice on a device associated with the second customer.

4. The system of claim 1, wherein the operations further comprise:
determining one or more selectable options corresponding to the first invoice based on information corresponding to the transaction; and
causing the one or more selectable options to be presented on a device of the first customer.

5. The system of claim 1, wherein the operations further comprise:
retrieving transaction history information associated with the merchant and the first customer;
determining a transaction risk associated with the transaction based on the transaction history information; and
communicating the transaction risk over the network that causes a display of the transaction risk on the merchant device.

6. The system of claim 4, wherein the operations further comprise:
receiving a selection of the one or more selectable options; and
responsive to receiving the selection of the one or more selectable options, determining one or more merchant actions that correspond to the selected action; and
causing the determined one or more merchant actions to be presented on the merchant device.

7. The system of claim 4, wherein the operations further comprise:
receiving a selection of the one or more selectable options; and
responsive to receiving the selection of the one or more selectable options, detecting a merchant action performed in response to the selection; and
causing the detected merchant action to be performed.

8. A method, comprising:
receiving an electronic communication from a merchant device corresponding to a transaction;
determining a transaction type corresponding to the transaction by analyzing content of the electronic communication;
responsive to the determining the transaction type corresponding to the transaction, accessing the at least one database to automatically identify an invoice configuration of the one or more invoice configurations that corresponds to the determined transaction type; and
in response to determining that the transaction corresponds to a first customer and a second customer, generating a first invoice for the first customer and a second invoice for the second customer using the invoice configuration, wherein generating the first and second invoice includes:
analyzing the content of the communication to determine a first invoice information and a second invoice information corresponding to the transaction;
analyzing the content of the communication to determine first customer information corresponding to the first customer and second customer information corresponding to the second customer; and
populating the first invoice with the first invoice information and first customer information and the second invoice with the second invoice information and the second customer information.

9. The method of claim 8, further comprising:
communicating the first invoice to a device of the first customer, wherein the communicating the first invoice causes a selectable option corresponding to one or more invoice actions to be displayed on the device of the first customer.

10. The method of claim 8, wherein the first invoice information includes the same information as the second invoice information.

11. The method of claim 8, further comprising:
determining one or more selectable options corresponding to the first invoice based on information corresponding to the transaction; and
causing the one or more selectable options to be presented on a device of the first customer.

12. The method of claim 8, further comprising:
retrieving transaction history information associated with the merchant and the first customer;
determining a transaction risk associated with the transaction based on the transaction history information; and
communicating the transaction risk over the network that causes a display of the transaction risk on the merchant device.

13. The method of claim 11, further comprising:
receiving a selection of the one or more selectable options; and
responsive to receiving the selection of the one or more selectable options, determining one or more merchant actions that correspond to the selected action; and
causing the determined one or more merchant actions to be presented on the merchant device.

14. The method of claim 11, further comprising:
receiving a selection of the one or more selectable options; and
responsive to receiving the selection of the one or more selectable options, detecting a merchant action performed in response to the selection; and
causing the detected merchant action to be performed.

15. A non-transitory machine-readable medium having stored thereon machine-readable instructions executable to cause a machine to perform operations comprising:
receiving an electronic communication from a merchant device corresponding to a transation;
determining a transaction type corresponding to the transaction by analyzing content of the electronic communication;
responsive to the determining the transaction type corresponding to the transaction, accessing the at least one database to automatically identify an invoice configuration of the one or more invoice configurations that corresponds to the determined transaction type; and
generating a first invoice for the transaction using the invoice configuration, wherein generating the first invoice includes:
analyzing the content of the communication to determine invoice information corresponding to the transaction; and
populating the first invoice with the determined invoice information.

16. The non-transitory machine-readable medium of claim 15, wherein the operations further comprise:
communicating the first invoice to a device of the first customer, wherein the communicating the first invoice causes a selectable option corresponding to one or more invoice actions to be displayed on the device of the first customer.

17. The non-transitory machine-readable medium of claim 15, wherein the operations further comprise:
determining that a second customer is associated with the transaction based on analyzing the content of the electronic communication;
responsive to the determining the transaction type corresponding to the transaction, accessing the at least one database to automatically identify a second invoice configuration of the one or more invoice configurations that corresponds to the determined transaction type and information associated with the second customer;
generating a second invoice using the second invoice configuration; and
communicating the second invoice over the network that causes a display of the second invoice on a device associated with the second customer.

18. The non-transitory machine-readable medium of claim 15, wherein the operations further comprise:
determining one or more selectable options corresponding to the first invoice based on information corresponding to the transaction; and
causing the one or more selectable options to be presented on a device of the first customer.

19. The non-transitory machine-readable medium of claim 15, wherein the operations further comprise:
retrieving transaction history information associated with the merchant and the first customer;
determining a transaction risk associated with the transaction based on the transaction history information; and
communicating the transaction risk over the network that causes a display of the transaction risk on the merchant device.

20. The non-transitory machine-readable medium of claim 18, wherein the operations further comprise:
receiving a selection of the one or more selectable options; and
responsive to receiving the selection of the one or more selectable options, determining one or more merchant actions that correspond to the selected action; and
causing the determined one or more merchant actions to be presented on the merchant device.
